(19) United States
(12) Patent Application Publication
(10) Pub. No.: US 2023/0234649 A1
(43) Pub. Date: Jul. 27, 2023

(54) TAILGATE SYSTEM WITH INTERCHANGEABLE UTILITY PODS

(71) Applicant: Erich Kai Stephan, San Rafael, CA (US)

(72) Inventor: Erich Kai Stephan, San Rafael, CA (US)

(21) Appl. No.: 18/100,499

(22) Filed: Jan. 23, 2023

Related U.S. Application Data
(60) Provisional application No. 63/301,648, filed on Jan. 21, 2022.

(51) Int. Cl. B62D 33/027

(52) U.S. Cl. CPC B62D 33/0273

(57) ABSTRACT

Vehicle tailgate systems are provided. Exemplary vehicle tailgate systems may include a tailgate wall having one or more cavities and one or more securement mechanisms. The cavities may be used to install a set of one or more interchangeable pods. Each pod may have a common interface that is configured to demountably install into the one or more cavities using the one or more securement mechanisms.

### CROSS-REFERENCE TO RELATED APPLICATIONS

The present patent application claims the priority benefit of U.S. provisional patent application No. 63/301,648 filed Jan. 21, 2022, the disclosure of which is incorporated by reference herein.

### BACKGROUND OF THE INVENTION

Currently, tailgates on most vehicles are limited to the function of enclosing a rear portion (e.g., cargo bed) of a vehicle. As a unique location on a vehicle—the area where cargo enters and exits a vehicle, there are many more functions possible with a tailgate. The present invention demonstrates a tailgate system where pods of various utility functions are interchangeably installed and removed from a vehicle tailgate to meet the variable utility of a vehicle during its day-to-day use.

### SUMMARY OF THE CLAIMED INVENTION

Embodiments of the present invention include vehicle tailgate systems. Exemplary vehicle tailgate systems may include a tailgate wall having one or more cavities and one or more securement mechanisms. The cavities may be used to install a set of one or more interchangeable pods. Each pod may have a common interface that is configured to demountably install into the one or more cavities using the one or more securement mechanisms.

### BRIEF DESCRIPTION OF THE DRAWINGS

FIG. 1 illustrates an isometric view of an exemplary tailgate system in a closed position.

FIG. 2 illustrates a close-up view of an exemplary tailgate system in an open position.

FIG. 3A illustrates an exemplary tailgate system during installation of multiple pods.

FIG. 3B illustrates an exemplary tailgate system following installation of the pods of FIG. 3A.

FIG. 4 illustrates an exemplary tailgate system into which a pod has been installed.

FIG. 5 illustrates an exemplary tailgate system into which an alternate pod has been installed.

FIG. 6 illustrates an exemplary tailgate system into which another alternate pod has been installed.

FIG. 7 illustrates an exemplary tailgate system with the alternate pod of FIG. 6 in an unfolded position.

FIG. 8 illustrates an exemplary tailgate system into which a variety of different interchangeable pods may be installed.

FIG. 9A illustrates an exemplary tailgate system into which yet another alternate pod has been installed.

FIG. 9B illustrates an exemplary tailgate system with the alternate pod of FIG. 9A in an unfolded position.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

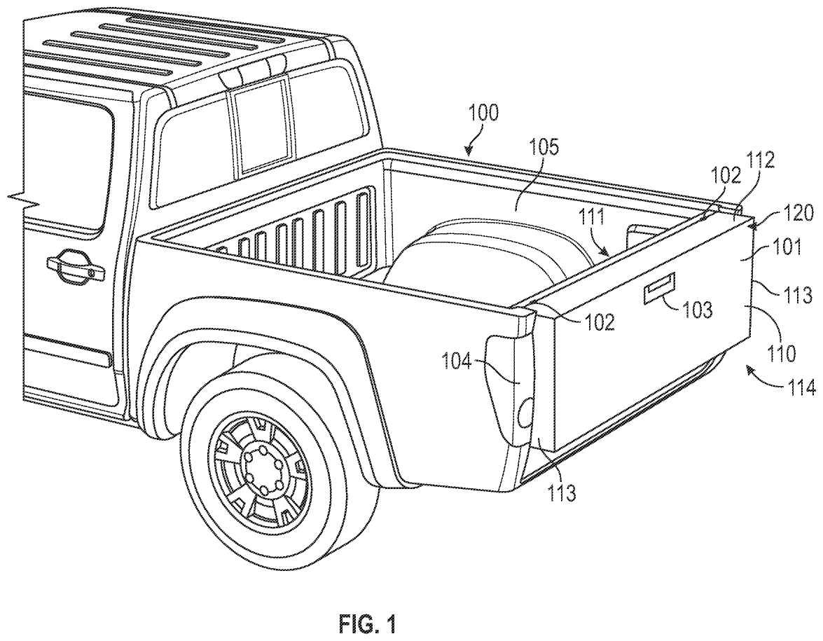

FIG. 1 illustrates an isometric view of an exemplary tailgate system 101 in a closed position 120. As illustrated, a tailgate system 101 may be configured to attach to a vehicle 100 (e.g., on the rear end of vehicle 100). In different implementations, tailgate system 101 may be attached to an existing tailgate of vehicle 100 or may replace an existing tailgate of vehicle 100.

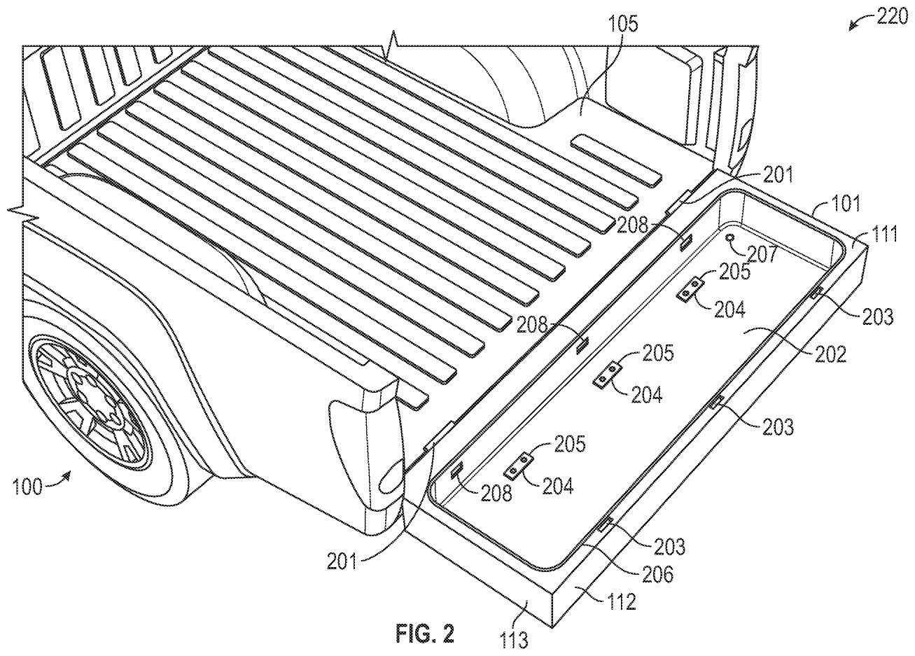

Tailgate system 101 may span the entire width of the vehicle 100 rear end, or may extend between the vehicle walls 104. The tailgate system 101 may have a release mechanism 103 disposed on the back surface of tailgate system 101 as shown. The release mechanism 103 may lock the tailgate system 101 into a closed position 120 as shown. When the release mechanism 103 is disengaged, the tailgate system 101 may swing down to an open position 220 as shown in FIG. 2.

The tailgate system 101 that swings from a substantially vertical position, hereafter called a closed position 120 as illustrated in FIG. 1 to a substantially horizontal position, hereafter called an open position 220 as illustrated in FIG. 2. In the closed position 120, the tailgate system 101 may latch or connect to vehicle walls 104 and/or other support structures of the vehicle.

The tailgate system 101 may include several walls. One wall may be described as an outside wall 110, which faces an exterior of the vehicle 100 when the tailgate system 101 is in a closed position 120. An inside wall 111 may face an interior of the vehicle 100 (such as towards the truck bed 105) when the tailgate system 101 is in a closed position 120, while a top wall 112 may face skyward when the tailgate system 101 is in a closed position 120. The tailgate system 101 may further include side walls 113 and a bottom wall 114. The tailgate system 101 may have a hinged connection 201 near the lower end, such as connecting on the side walls 113 near the bottom wall 114, or a hinge connected from the bottom wall 114 to the vehicle 100.

FIG. 2 illustrates a close-up view of an exemplary tailgate system 101 in an open position 220. The tailgate system 101 may pivotally connect to the vehicle 100 with one or more hinges 201. The hinges 201 may be normal hinges as shown or may be gooseneck type hinges to extend the tailgate further away from the vehicle than a normal hinge when the tailgate system 101 is transitioned from a closed position 120 to the open position 220. The tailgate system 101 may articulate around the axis of the hinges 201 from a close position 120 to an open position 220.

In alternative embodiments of the present invention, hinges 201 may be a corner hinge, lift-off hinge, offset hinge, leaf hinge, concealed hinge, gooseneck hinge, or similar suitable design. The tailgate system 101 may have one or more dampers, springs, or other compressible members, or an electric motor or actuator to aid in transitioning the tailgate system 101 from an open position 220 to a closed position 120. Such devices (not illustrated) may reside in the vehicle walls 104, under the truck bed 105, or within the tailgate system 101. In some example embodiments, the compressible member may generate potential energy when the tailgate system 101 transitions from a closed position 120 to an open position 220. When moving the tailgate system 101 from an open position 220 to a closed position 120, the potential energy may be used to aid in transitioning the tailgate system 101 against the force of gravity. The potential energy may be less than the force due to gravity on the tailgate system 101, thereby not moving the tailgate system 101 without additional assistance, e.g., by hand or an electric device.

The tailgate system 101 may have one or more cavities 202 accessible from the inside wall 111, top wall 112, and/or side walls 113. In one implementation, a single cavity 202 may occupy a majority of the volume internal of the tailgate system 101. In other implementations, the tailgate system 101 may have multiple cavities 202 of the same size or different sizes separated by an interior wall, brace, baffle, fence, bar, beam, cable, or some other dividing body. In another example, a smaller cavity 202 may reside below or within a larger cavity 202, resulting in the cavity 202 being a stair-stepped shape, or inverse stepped pyramid shape.

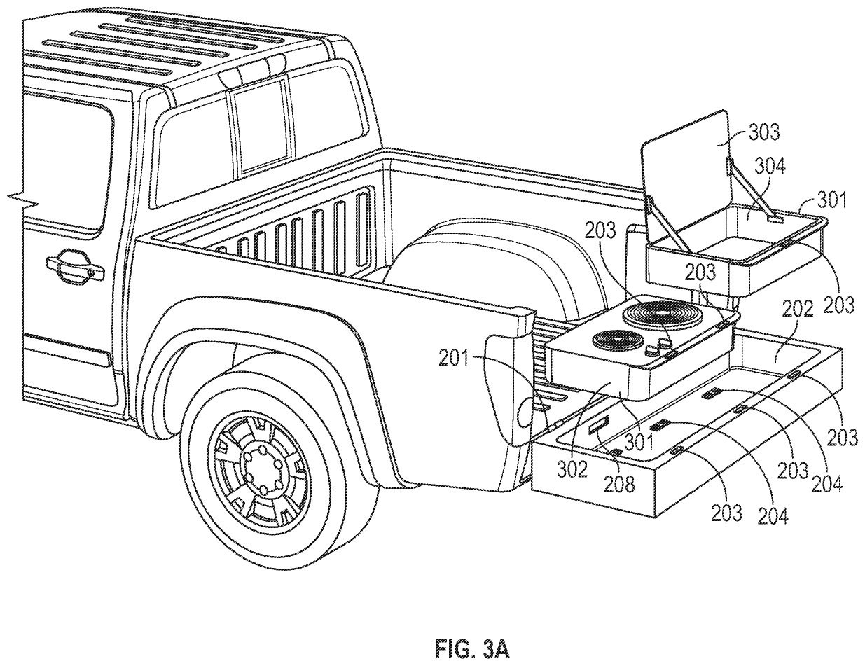

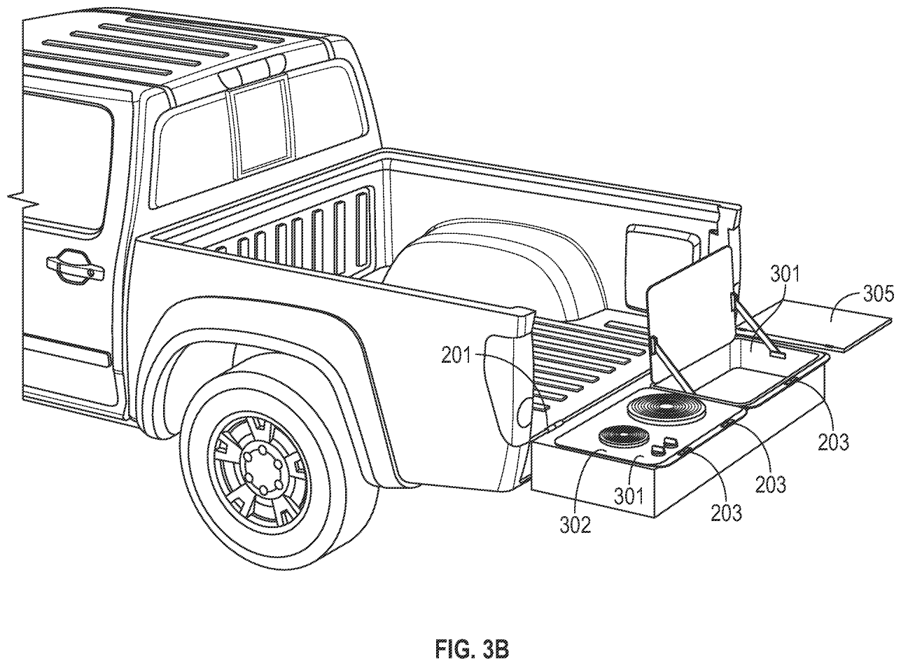

The one or more cavities 202 are configured to receive and demountably secure one or more interchangeable pods 301 (as illustrated in FIG. 3A). A cavity 202 may have one or more locking mechanisms 203 to secure one or more interchangeable pods 301 to the cavity 202. The locking mechanism 203 may be a latch, snap, fastener, rotatable handle, cam device, t-bolt, slide, hook, magnet, or other apparatus sufficient to secure the interchangeable pod 301 within the cavity 202. The locking mechanism 203 may be accessible from a surface of the tailgate system 101, such as the inside wall 111, side walls 113, or top wall 112, or from a surface on the interchangeable pod 301. When installed into a cavity 202, an interchangeable pod 301 may be flush with the inside wall 111 of the tailgate system 101 or may protrude above the surface of the inside wall 111. When the tailgate system 101 is in the closed position 120, an interchangeable pod 301 may protrude into the open space of a truck bed 105 beyond the inside wall 111. The locking mechanism 203 to secure one or more interchangeable pods 301 may only be operable when the tailgate system 101 is in an open position 220, and may be inoperable, such as being disengaged, when the tailgate system 101 is in a closed position 120.

The cavity 202 may have one or more electrical conductors 204 configured to interface with one or more corresponding electrical conductors 204 on an interchangeable pod 301. When an interchangeable pod 301 is installed into a cavity 202, the one or more electrical conductors 204 may interface with one or more electrical conductors on the interchangeable pod 301 to create an electrical pathway from the vehicle to the interchangeable pod 301. A plurality of electrical conductors 204 in the cavity 202 may interface with one interchangeable pod 301, or they may interface with multiple interchangeable pods 301. A seal mechanism 205, such as a rubber, silicone, neoprene, EPMD or other suitable material may surround the one or more electrical conductors 204 in the cavity 202, on an interchangeable pod 301, or on both, in order to prevent moisture from accessing the electrical conductors 204 when an interchangeable pod 301 is installed into a cavity 202. The electrical conductors 204 in a cavity 202 may have a cover, flap, plate, gasket, boot, skirt, compressible body, or other body to substantially protect the electrical conductors 204 from the outside environment when all or a portion of a cavity 202 is vacant from an interchangeable pod 301.

The cavity 202 or the interchangeable pod 301 may have a pod seal 206 to prevent moisture intrusion into the cavity 202. The pod seal 206 may be disposed around the perimeter of the cavity 202 as depicted in FIG. 2. In alternative embodiments, a pod seal 206 may be disposed around the perimeter of an the interchangeable pod 301. A cavity 202 may have a drain port 207 located at a lower area to allow liquid to drain from a cavity 202 when the tailgate system 101 is in a closed position 120 or open position 220. The drain port 207 may be recessed in the bottom of the cavity 202 to enable liquid to collect. One or more mounting ports 208 may be disposed on one or more interior walls of the cavity 202, as shown, or disposed on the inside wall 111. The mounting ports 208 may be configured to cooperate with one or more mounting flanges, pins, tongues, hooks, or similar protrusions on an exterior wall of an interchangeable pod 301 to aid in securing the interchangeable pod 301 in the cavity 202. In some example embodiments, the mounting ports 208 may be disposed on an opposite wall from one or more locking mechanism 203 such that the interchangeable pod 301 is secured on opposite sides.

FIG. 3A illustrates an exemplary tailgate system during installation of multiple interchangeable pods 301, and FIG. 3B illustrates an exemplary tailgate system 101 following installation of the interchangeable pods 301 of FIG. 3A. In particular, FIG. 3A depicts an isometric view of the tailgate system 101 in an open position 220 with two interchangeable pods 301 positioned over a single cavity 202, representing one exemplary embodiment of the present invention. FIG. 3B depicts the same view as FIG. 3A, albeit with the interchangeable pods 301 demountably secured into the tailgate system 101. In an example installation sequence, first interchangeable pod 301 may be lowered into the cavity 202 so that a mounting flange on the interchangeable pod 301 engages with a mounting port 208 in the cavity 202. The interchangeable pod 301 may be angled or pressed down further into the cavity 202 so locking mechanisms 203 disposed on the tailgate system 101 or on interchangeable pod 301 cooperate to demountably secure the interchangeable pod 301 into the cavity 202. As an example method for removing an interchangeable pod 301, one or more locking mechanisms 203 may be disengaged, such as through a button, handle, lever, actuator, solenoid, motor, cam, cable, or other suitable device. The interchangeable pod 301 may therefore be allowed to be lifted from a first side (e.g., the side with the locking mechanism 203). Then, the mounting flange may be disengaged from the mounting port 208 and the interchangeable pod 301 removed from the cavity 202.

The interchangeable pods 301 may have several different modes of utility and form factors, though each of the interchangeable pods 301 may have a common or universal interface to demountably secure into a cavity 202. Such universal interface may be defined as universal in relation to the size and location of a pair of mounting ports 208 and mounting flanges on the interchangeable pod 301, a universal set of locking mechanisms 203, and one or more exterior dimensions of an interchangeable pod 301, such as the width. A single interchangeable pod 301 may occupy more than one cavity 202, thereby occupying up to an entirety of the available cavity space in tailgate system 101.

In some implementations, multiple interchangeable pods 301 may demountably secure into a tailgate system 101 at the same time, such as shown in FIG. 3B. As an example embodiment of the present invention, a tailgate system 101 may have one cavity 202 accessible from the inside wall 111 and providing the majority of the space available within the tailgate system 101 for an interchangeable pod 301 installation. The interchangeable pods 301 may each take up the same or different amounts of volume within the cavity. For example, a first interchangeable pod 301 may be placed to occupy a right 40% of the width of the cavity 202, a second interchangeable pod 301 may be placed to occupy a middle 20% of the width, and a left interchangeable pod 301 may be placed to occupy the final 40% of the width. A right and center interchangeable pods 301 could be removed, and then a larger single interchangeable pod 301 that itself occupies a left 60% of the cavity 202 could be installed. In another example, a user may have a single interchangeable pod 301 installed in the tailgate system 101.

As shown in FIGS. 3A and 3B, one example interchangeable pod 301 may include a heating element 302, such as an induction stovetop or electrical heating coil. An interchangeable pod 301 may have a collapsible vessel for holding liquid, such as water, temporarily or for a longer duration. An interchangeable pod 301 may have a pivotally attached plate 303 with one or more storage compartments 304 under the plate. An interchangeable pod 301 may have a flat work surface 305 that folds out along an edge, or a work surface with grooves, apertures, or tapers to drain liquid, such as found on a kitchen cutting board.

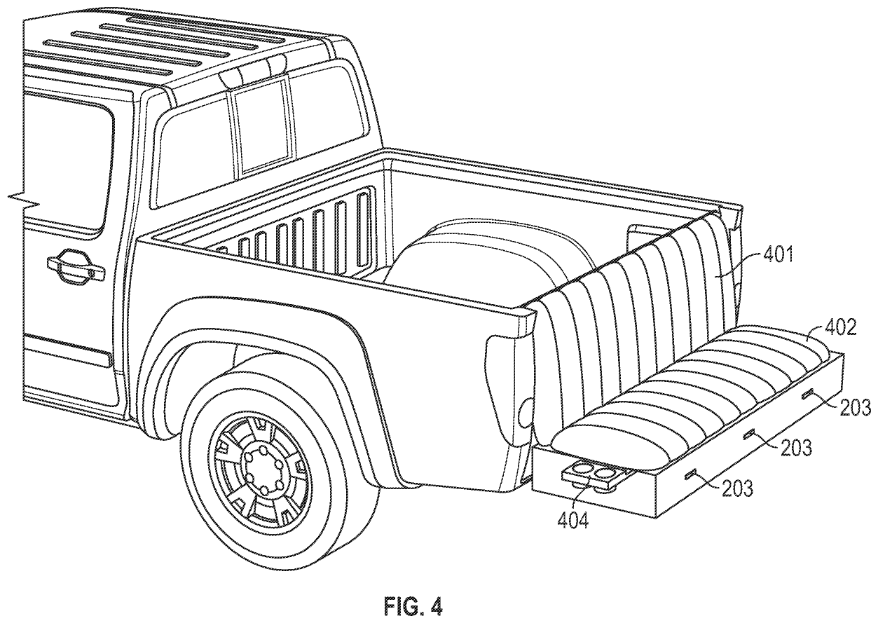

FIG. 4 illustrates an exemplary tailgate system into which a pod has been installed. As illustrated, the interchangeable pod 301 has a fold-up panel 401, which may further include a cushioned or fabric surface, and flush panel 402 that may be cushioned or a fabric surface. With this example interchangeable pod 301 installed, the tailgate system 101 may provide a cushioned seat facing away from the vehicle. An interchangeable pod 301 may further have heated or non-heated cupholders 404, either as retractable from the side of an interchangeable pod 301 or as recesses, or other similar formation. An interchangeable pod 301 may have a fold-open seat with an electrical warming device within the seat. In this example embodiment, the one or more locking mechanisms 203 may be disposed on the top wall 112.

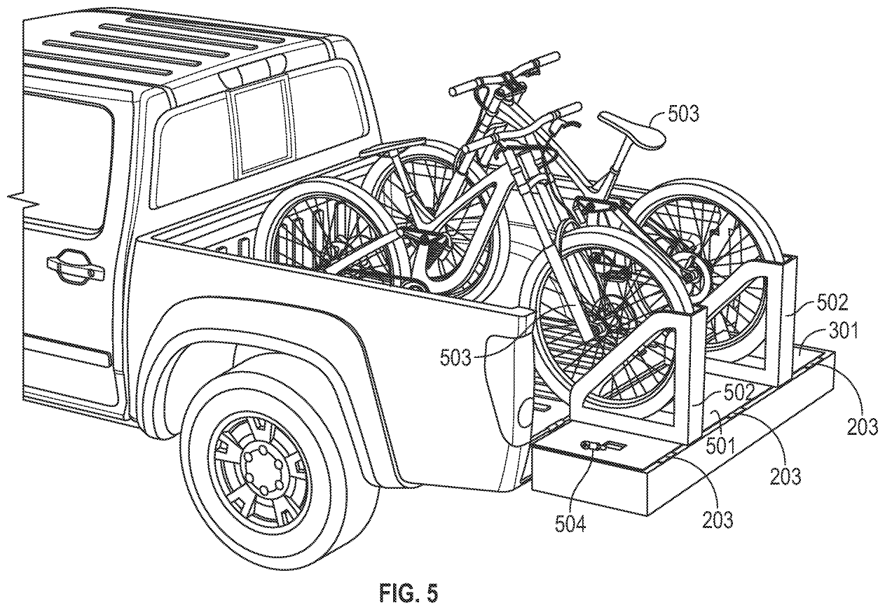

FIG. 5 illustrates an exemplary tailgate system into which an alternate pod has been installed. As shown in FIG. 5, an interchangeable pod 301 may have one or more bicycle braces 502 to secure a bicycle wheel, or to secure a bicycle 503. An interchangeable pod 301 may have an air compressor nozzle 504 to supply compressed air from an air compressor housed in the interchangeable pod 301. The plate under the bicycle brace 502 may be pivotally attached to one side of the interchangeable pod 301 such that the plate under the bicycle brace 502 can articulate open to access a storage compartment within the interchangeable pod 301. A releasable locking mechanism may secure the plate under the bicycle brace 502 from pivotally opening unintentionally.

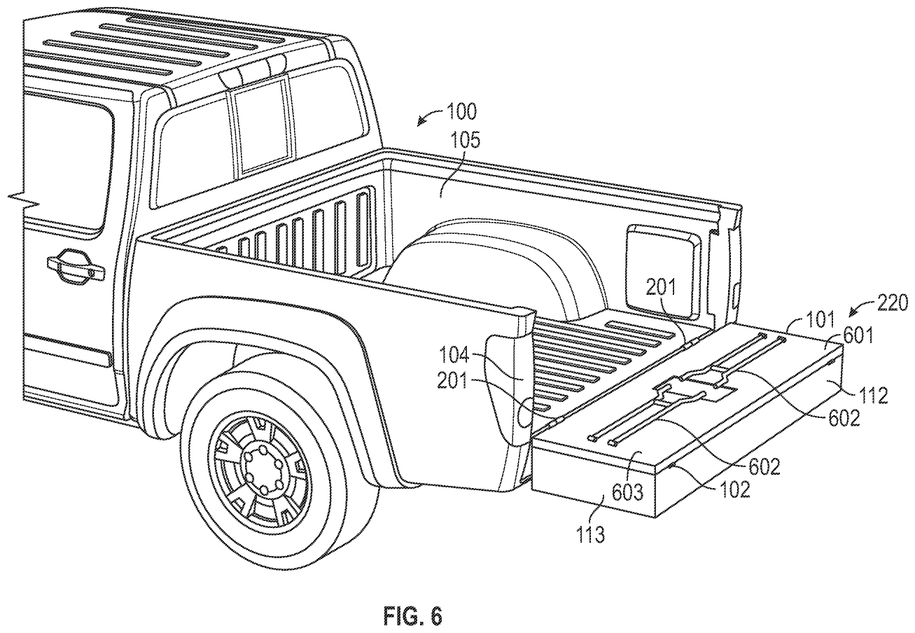

FIG. 6 illustrates an exemplary tailgate system into which another alternate pod has been installed. As illustrated, the tailgate system 101 has a demountably attached cover plate 601. The tailgate system 101 may have one or more cover plates 601 that cover one or more installed interchangeable pods 301 or one more cavities 202 that are vacant of an interchangeable pod 301. The cover plate 601 may be integral to an interchangeable pod 301, or it may be a separate body from an interchangeable pod 301. The cover plate 601 may be a contiguous component, may have one or more hinged partitions, or may have one or more removable sections, such as with a fastener, twist-off cap, latch, threaded or cam-type connection, or other securing mechanism.

As shown in the FIG. 6, the cover plate 601 may be demountably installed to the tailgate system 101 with one or more releasable hinges 102, where the hinges secure one side of the cover plate 601 to the tailgate system 101 when the cover plate 601 is, for example, zero to 180 degrees relative to the tailgate, but may disengage upon surpassing a designed angle, such as 200 degrees. In other example embodiments, the cover plate 601 may demountably install to the tailgate system 101 with one or more hand operable releasable locking mechanisms, such as a latch, or it may be permanently pivotally affixed to the tailgate system 101. The cover plate 601 may have a securement mechanism to demountably install the cover plate 601 to the tailgate system 101, such as a latch, snap, catch, fastener, cam device, handle, hook, tongue-and-groove, or similar hand or tool operable mechanism. In one example embodiment, the cover plate 601 may have a first body that demountably attaches to a tailgate system 101, the first body is connected to a second body via a hinge. In this example, the cover plate 601 may be installed to a tailgate system 101 for occasional use, with the first body rigidly connected, and the second body opening at the hinge to allow routine accessibility to the cavity 202.

A first surface 603 of the cover plate 601 may act as the protective wall of the tailgate system 101 for one or more installed interchangeable pods 301, and a second opposite surface substantially coincident with the inside wall 111 of the tailgate system 101. The cover plate 601 may demountably attach to the tailgate system 101 along a lip formed where the top wall extends beyond the surface of the inside wall 111, or along a lip formed where the bottom wall 114 overhangs the inside wall 111. In the example embodiment where the cover plate 601 is configured as more than one body connected with one or more hinges 102, a first partition may be demountable secured to the tailgate system 101 with one or more securement mechanisms, such as a latch or fastener, or through cam fit. A second partition may have different securement mechanism, such as a latch or a catch that is hand operable, tool operable, or key operable. When the cover plate 601 is in a close position, it may form a watertight seal with the inside panel of the tailgate system 101 to prevent water or moisture from accessing a cavity 202 or an interchangeable pod 301.

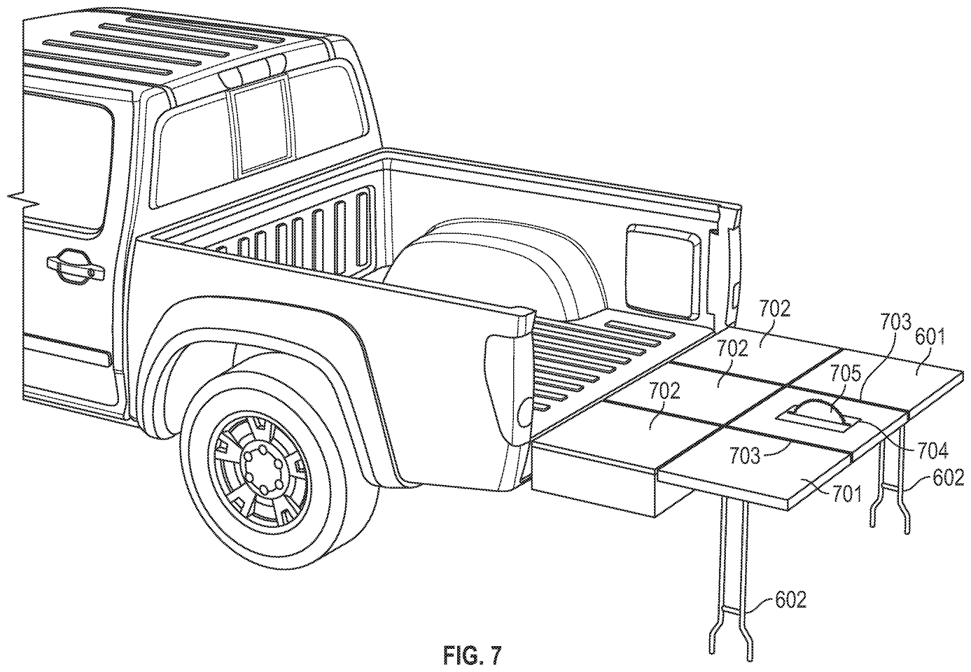

FIG. 7 illustrates an exemplary tailgate system with the alternate pod of FIG. 6 in an unfolded position. As depicted in FIG. 7, the cover plate 601 may connect to the tailgate system 101 near or on the top wall 112 to allow the cover plate 601 to swing to a substantially 180-degree position from its nominal position, e.g. from the inside wall 111, representing one example of the present invention. In this open position 220, the second surface 701 (now facing skyward), may be flush with the inside wall 111 of the tailgate system 101, or it may be flush with one or more top surfaces 702 of one or more installed interchangeable pods 301. When the cover plate 601 is opened to this open position, a disengable latch mechanism may rigidly secure the cover plate 601 and tailgate system 101 into a substantially co-planar position. In another example embodiment of the present invention, the cover plate 601 may be demountably installed onto hinges 102 located at either the top wall 112 or near the bottom wall 114.

The first surface 603 (now facing towards earth) may have one or more legs 602 that are foldable or retractable and telescoping to interface with a ground surface in order to provide additional support and structural integrity to the cover plate 601 and tailgate system 101. The second surface 701 may have one or more engagable features 703, such as grooves, tracks, apertures, or T-slots to configure with heads of fasteners, T-bolts, clamps, slides, fasteners, or other devices. The cover plate 601 may attach to the tailgate system 101 with a standard hinge 102, a gooseneck hinge or a double hinge. In embodiments where the cover plate 601 is more than one partition and is permanently or demountably connected to the tailgate system 101, the middle partition may be coincident with the top wall 112 and the end partition may be coincident with the inside wall 111 when the cover plate 601 is in a closed position.

As shown in FIG. 7, an example cover plate 601 may have one or more tool apertures 704 configured to demountably attach a power tool 705, such as a portable circular saw, chop saw, jig saw, orbital sander, grinder, abrasive sander, sharpening wheel, or other similar device. An interchangeable pod 301 may have a fold-out tabletop that may have grooves, tracks, apertures, and or other engagable features to create a work surface. A fold out tabletop may have one or more apertures configured to demountably attach a portable circular saw, chop saw, jig saw, orbital sander, grinder, abrasive sander, sharpening wheel, or other similar device. A cover plate 601 or a fold-out tabletop may have one or more apertures configured to demountably attach one or more tools, such as a router, sander, drill, vice, clamp, table saw, circular saw, vacuum, or another common tool. An interchangeable pod 301 may have one or more electrical outlets (such as a common household 110v outlet), USB ports, and other electrical connectors.

An interchangeable pod 301 may have retractable supports or brackets to hold a surfboard, wakeboard, kiteboard, paddle board, kayak, canoe, rowing shell, or other curved body. An interchangeable pod 301 may have a retractable footstep that folds around the top wall 112 of the tailgate system 101 using one or more hinges to be substantially parallel with and below an open position 220 tailgate system 101. An interchangeable pod 301 may have a collapsible canopy, such as tent, sunshade, or rainfly. An interchangeable pod 301 may have one or more static or retractable hooks for attaching various items, such as a trash bag or clothes hanger. An interchangeable pod 301 may have one or more speakers that are mounted flush or articulate or slide into an upright position when the tailgate system 101 is in an open position 220.

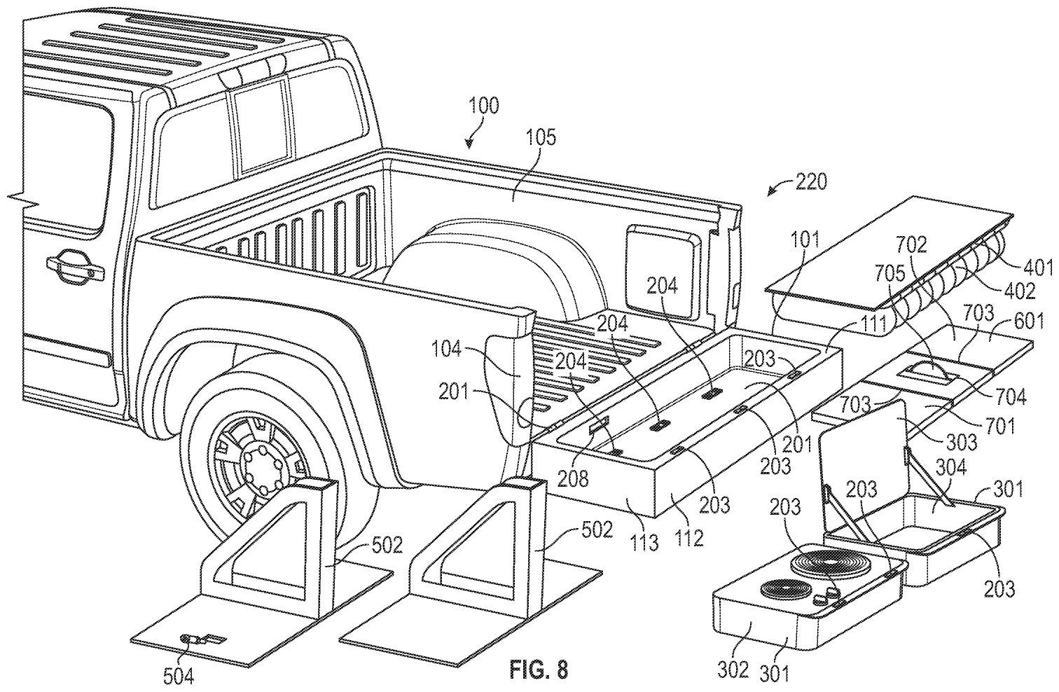

FIG. 8 illustrates an exemplary tailgate system 101 into which a variety of different interchangeable pods 301 may be installed. As illustrated, the tailgate system 101 may have a cavity 202 into which one or more of the interchangeable pods 301 may be demountably installed 301. As illustrated, the interchangeable pods 301 may each have different sizes and configurations. Different combinations of one or more interchangeable pods 301 may be installed into the same tailgate system 101.

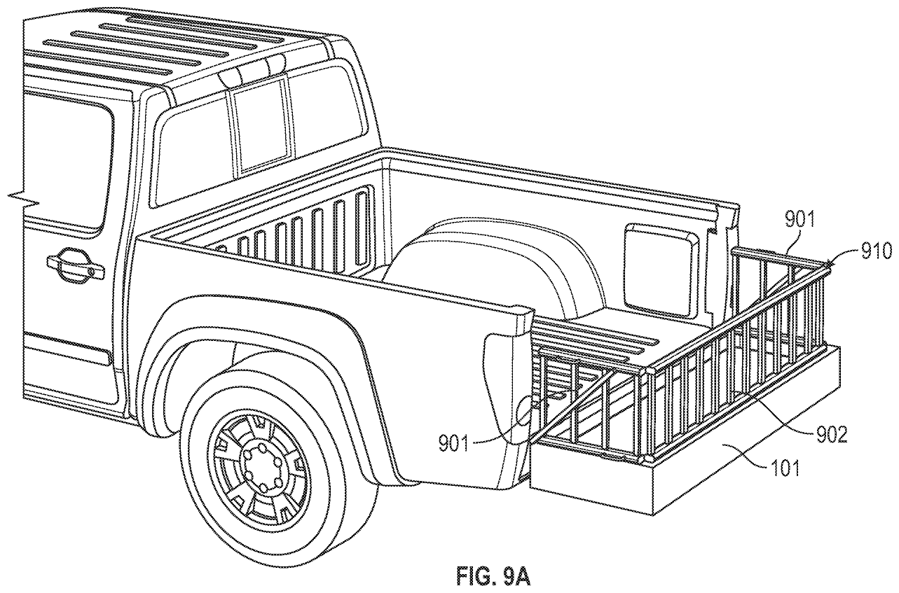

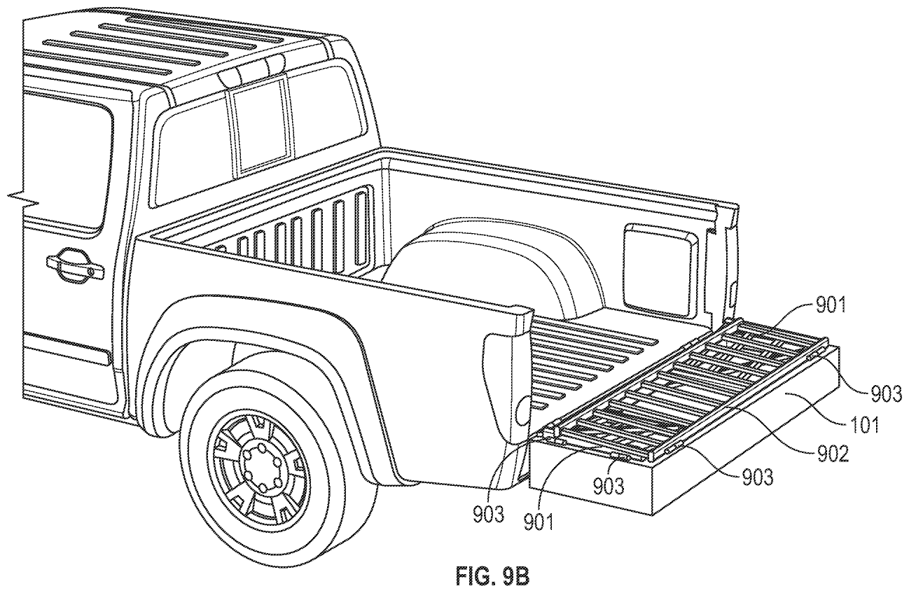

FIG. 9A illustrates an exemplary tailgate system into which yet another alternate pod has been installed, and FIG. 9B illustrates an exemplary tailgate system with the alternate pod of FIG. 9A in an unfolded position. As illustrated, the cover plate 601 has a plurality of apertures disposed throughout its surface, thereby allowing air to flow through but preventing larger objects from sliding out of the truck bed 105. In other example embodiments, the cover plate 601 may be solid, hollow, a lattice, honeycomb structure, a grid structure, series of beams or tubes, a screen, a mesh, net, framed net, frame, fabric, or other suitable construction. As shown in FIG. 9A, a cover plate 601 is shown as a back fence 902 in an upright position, with a side fence 901 on either end and perpendicular to back fence 902. The back fence 902 and side fence 901 may be pivotally attached to the tailgate system 101 with fence hinges 903, or to the top surface of an interchangeable pod 301 with fence hinges 903. FIG. 9B depicts the side fences 901 folded into a recessed surface of an interchangeable pod 301 or the tailgate system 101, and a back fence 902 down over the side fences 901. Fence hinges 903 may be a corner hinge, lift-off hinge, offset hinge, leaf hinge, concealed hinge, gooseneck hinge, or similar suitable design. In some example embodiments, the side fence 901 and back fence 902 may be removable from the interchangeable pod 301, or may pivotally attach such that one or more of the fences 901 and 902 rotate approximately 270 degrees from the folded down position shown in FIG. 9B, thereby allowing unobstructed access into the truck bed 105. In other example embodiments, the back fence 902 may fold into the closed position shown in FIG. 9B and have the exterior surface of the back fence 902 substantially coincident with the bottom surface of the truck bed 105. Vehicle lights 910 may be disposed in the back fence 902 or side fences 901 and configured to activate when the tailgate system 101 is in an open position 220 and the back fence 902 and side fence 901 are in an open position as depicted in FIG. 9A. Vehicle lights 910 may be configured to operate as running lights for the vehicle, such as brake lights, turn signals, reverse lights, etc.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A vehicle tailgate system comprising:
a tailgate wall having one or more cavities and one or more securement mechanisms; and
a set of one or more interchangeable pods, each pod having a common interface configured to demountably install into the one or more cavities using the one or more securement mechanisms.

2. The vehicle tailgate system of claim 1, wherein each of the interchangeable pods is configured differently in accordance with a different functional use.

3. The vehicle tailgate system of claim 1, wherein a substantially watertight seal is formed between at least one of the interchangeable pods and a wall of one of the cavities when the at least one interchangeable pod is installed into the tailgate wall.

4. The vehicle tailgate system of claim 1, wherein at least one of the interchangeable pods includes an electrical conductor configured to form an electrical connection to a corresponding electrical conductor in one of the cavities.

5. The vehicle tailgate system of claim 1, wherein at least one of the cavities is configured to hold a plurality of the interchangeable pods at a time.

6. The vehicle tailgate system of claim 1, wherein at least one of the interchangeable pods includes a heating element disposed on a top surface.

7. The vehicle tailgate system of claim 1, wherein at least one of the interchangeable pods includes a mounting bracket disposed on a top surface, the mounting bracket configured to secure a wheel.

8. The vehicle tailgate system of claim 1, wherein at least one of the interchangeable pods includes one or more apertures configured to demountably install a corresponding power tool.

9. The vehicle tailgate system of claim 1, wherein at least one of the interchangeable pods includes one or more securable compartments accessible from a top surface.

10. The vehicle tailgate system of claim 1, wherein at least one of the interchangeable pods includes a retractable containment barrier disposed in a top surface.

11. The vehicle tailgate system of claim 10, wherein the retractable containment barrier includes a surface having a plurality of apertures.

12. The vehicle tailgate system of claim 1, further comprising a plate configured to demountably install onto a long edge of the tailgate wall, wherein the plate is configured to pivot around a connection point from a closed position to an open position.

13. The vehicle tailgate system of claim 12, wherein the plate has a first surface and a second surface, the first surface further from the tailgate wall than the second surface, wherein the second surface is substantially coincident with the tailgate wall when in a closed position.

14. The vehicle tailgate system of claim 12, wherein the plate further includes one or more retractable legs disposed on a first surface.

15. The vehicle tailgate system of claim 12, wherein the plate further includes an aperture configured to demountably secure a corresponding power tool.

16. The vehicle tailgate system of claim 12, wherein the plate further includes one or more tracks disposed on a surface for securing a bracket.

17. The vehicle tailgate system of claim 12, wherein the plate is configured to disengably lock into a locked position in which the second surface is substantially coincident with an interior-facing portion of the tailgate wall.

18. The vehicle tailgate system of claim 1, wherein at least one of the securement mechanisms is a tongue-and-groove connection on one side of one of the cavities and a latch of another side of the cavity.

19. The vehicle tailgate system of claim 1, wherein at least one of the cavities further includes an aperture.

20. The vehicle tailgate system of claim 1, wherein an exterior surface of the tailgate wall is substantially coincident with distal ends of one or more vehicle side walls when the tailgate wall is in a closed position.
